(19) United States
(12) Patent Application Publication
(10) Pub. No.: US 2026/0004961 A1
(43) Pub. Date: Jan. 1, 2026

(54) INDUCTOR COMPONENT

(71) Applicant: CHILISIN ELECTRONICS CORP., Taoyuan City (TW)

(72) Inventors: Yan-Fu CHOU, Taoyuan City (TW); Jui-Min CHUNG, Taoyuan City (TW); Chia-Chen CHEN, Taoyuan City (TW)

(21) Appl. No.: 19/243,739

(22) Filed: Jun. 20, 2025

Related U.S. Application Data
(60) Provisional application No. 63/665,246, filed on Jun. 27, 2024.

(30) Foreign Application Priority Data
May 8, 2025 (TW) 114117366

(51) Int. Cl. H01F 27/28; H01F 27/02

(52) U.S. Cl. CPC H01F 27/28; H01F 27/02

(57) ABSTRACT

An inductor component is provided. The inductor component includes a first winding and a second winding. The first winding includes: two first bonding portions, two first bending portions and a first main portion. The first bonding portions extend along a first direction. The first bending portions are connected to the first bonding portions and extend along a second direction. The first main portion is connected between the first bending portions and defines a winding surrounded area of the first winding. The second winding includes: two second bonding portions, two second bending portions and a second main portion. The second bonding portions extend along a third direction. The second bending portions are connected to the second bonding portions and extend along a fourth direction. The second main portion is connected between the second bending portions and defines a winding surrounded area of the second winding.

### CROSS-REFERENCE TO RELATED APPLICATIONS

This application claims priority to U.S. Provisional Application No. 63/665,246, filed on Jun. 27, 2024 and Taiwan Application Serial Number 114117366, filed May 8, 2025, which are herein incorporated by reference.

### BACKGROUND

### Field of Invention

The present invention relates to an inductor component. More particularly, the present invention relates to an inductor component adapted to a Trans-inductor Voltage Regulator (TLVR).

### Description of Related Art

Inductors are passive components commonly used in various circuits. When current flows through an inductor, the inductor converts electrical energy into magnetic field energy. A trans-inductor voltage regulator (TLVR) is a regulator using a transformer winding as an output inductor. Since the TLVR has smaller voltage ripples, smaller current ripples, and better thermal performance, the TLVR is widely used in various electronic products. However, the inductor component of the TLVR has a larger size causing difficulties in applying the TLVR to thin portable products.

### SUMMARY

Embodiments of the present invention provide a low-profile inductor component having a lower height adapted to the thin portable products.

In accordance an embodiment of the present invention, the inductor includes: a first winding and a second winding. The first winding includes: two first bonding portions, two first bending portions and a first main portion. The first bonding portions extend along a first direction. The first bending portions are connected to the first bonding portions and extend along a second direction different from the first direction. The first main portion is connected between the first bending portions and defines a first winding surrounded area of the first winding. The second winding includes: two second bonding portions, two second bending portions and a second main portion. The second bonding portions extend along a third direction. The second bending portions are connected to the second bonding portions and extend along a fourth direction different from the third direction. The second main portion is connected between the second bending portions and defines a second winding surrounded area of the second winding. The first main portion is conformal to the second main portion.

In some embodiments, the first bonding portions and the second bonding portions extend along a plane, and the first main portion and the second main portion extend along the plane.

In some embodiments, the first bending portions and the second bending portions do not extend along the plane, and an angle between the first bending portions and the plane is greater than 0 degrees, and an angle between the second bending portions and the plane is greater than 0 degrees.

In some embodiments, the angle between the first bending portions and the plane is 90 degrees, and an angle between the second bending portions and the plane is 90 degrees.

In some embodiments, the inductor component further includes a housing. The first winding and the second winding are disposed in the housing. The first bonding portions and the second bonding portions are disposed on a bottom surface of the housing.

In some embodiments, the inductor component further includes a housing. The first winding and the second winding are disposed in the housing. The first bonding portions are disposed on a bottom surface of the housing. The second bonding portions are disposed on a side surface of the housing, and the side surface is adjacent to the bottom surface.

In some embodiments, the inductor component further includes a housing. The second main portion is located in the first winding surrounded area.

In accordance an embodiment of the present invention, the inductor includes: a first winding and a second winding. The first winding includes: two first bonding portions, two first bending portions and a first main portion. The first bonding portions extend along a first direction. The first bending portions are connected to the first bonding portions and extend along a second direction different from the first direction. The first main portion is connected between the first bending portions and defines a first winding surrounded area of the first winding. The second winding includes: two second bonding portions, two second bending portions and a second main portion. The second bonding portions extend along a third direction. The second bending portions are connected to the second bonding portions and extend along a fourth direction different from the third direction. The second main portion is connected between the second bending portions and defines a second winding surrounded area of the second winding. The second main portion is located in the first winding surrounded area, and there is a gap located between the first main portion and an adjustment portion of the second main portion.

In some embodiments, the first bonding portions and the second bonding portions extend along a plane, and the first main portion and the second main portion extend along the plane.

In some embodiments, the first bending portions and the second bending portions do not extend along the plane, and an angle between the first bending portions and the plane is greater than 0 degrees, and an angle between the second bending portions and the plane is greater than 0 degrees.

In some embodiments, the angle between the first bending portions and the plane is 90 degrees, and an angle between the second bending portions and the plane is 90 degrees.

In some embodiments, the inductor further includes a housing. The first winding and the second winding are disposed in the housing. The first bonding portions and the second bonding portions are disposed on a bottom surface of the housing.

In some embodiments, the inductor further includes a housing. The first winding and the second winding are disposed in the housing. The first bonding portions are disposed on a bottom surface of the housing. The second bonding portions are disposed on a side surface of the housing, and the side surface is adjacent to the bottom surface.

In accordance an embodiment of the present invention, the inductor component includes: a first winding and a second winding. The first winding includes: two first bonding portions, two first bending portions and a first main portion. The first bonding portions extend along a first direction. The first bending portions are connected to the first bonding portions and extend along a second direction different from the first direction. The first main portion is connected between the first bending portions and defines a first winding surrounded area of the first winding. The second winding includes: two second bonding portions, two second bending portions and a second main portion. The second bonding portions extend along a third direction. The second bending portions are connected to the second bonding portions and extend along a fourth direction different from the third direction. The second main portion is connected between the second bending portions and defines a second winding surrounded area of the second winding. The inductor component further includes a magnetic body having a top portion and a bottom portion. The bottom portion is located under the top portion. The bottom portion includes: a groove portion and a center portion. The groove is configured to receive the first winding and the second winding. The center portion is located in the first winding surrounded area and the second winding surrounded area.

In some embodiments, the magnetic body comprises ferromagnetic material particles and insulating material particles.

### BRIEF DESCRIPTION OF THE DRAWINGS

The invention can be more fully understood by reading the following detailed description of the embodiment, with reference made to the accompanying drawings as follows.

FIG. 1A is a schematic diagram showing a 3D structure of an inductor component in accordance with embodiments of the present invention.

FIG. 1B is a schematic diagram showing side views of a first winding and a second winding of the inductor component.

FIG. 2A is a schematic diagram showing a 3D structure of an inductor component in accordance with embodiments of the present invention.

FIG. 2B is a schematic diagram showing side views of a first winding and a second winding of the inductor component.

FIG. 3A is a schematic diagram showing a 3D structure of an inductor component in accordance with embodiments of the present invention.

FIG. 3B is a schematic diagram showing side views of a first winding and a second winding of the inductor component.

FIG. 4A is a schematic diagram showing a 3D structure of an inductor component in accordance with embodiments of the present invention.

FIG. 4B is a schematic diagram showing side views of a first winding and a second winding of the inductor component.

FIG. 5A is a schematic diagram showing a 3D structure of an inductor component in accordance with embodiments of the present invention.

FIG. 5B is a schematic diagram showing side views of a first winding and a second winding of the inductor component.

FIG. 5C is a schematic diagram showing a top view of the first winding and the second winding of the inductor component.

FIG. 6A is a schematic diagram showing a 3D structure of an inductor component in accordance with embodiments of the present invention.

FIG. 6B is a schematic diagram showing side views of a first winding and a second winding of the inductor component.

FIG. 6C is a schematic diagram showing a top view of the first winding and the second winding of the inductor component.

FIG. 7A is a schematic diagram showing a bottom portion and a top portion of a magnetic body, the first winding and the second winding.

FIG. 7B is a schematic diagram showing combination of the winding group and the magnetic body.

FIG. 8 is a schematic diagram showing a flow chart of a method for manufacturing the above inductor component in accordance with embodiments of the present invention.

### DETAILED DESCRIPTION

Specific embodiments of the present invention are further described in detail below with reference to the accompanying drawings, however, the embodiments described are not intended to limit the present invention and it is not intended for the description of operation to limit the order of implementation. Moreover, any device with equivalent functions that is produced from a structure formed by a recombination of elements shall fall within the scope of the present invention. Additionally, the drawings are only illustrative and are not drawn to actual size.

The using of “first”, “second”, “third”, etc. in the specification should be understood for identifying units or data described by the same terminology but are not referred to particular order or sequence.

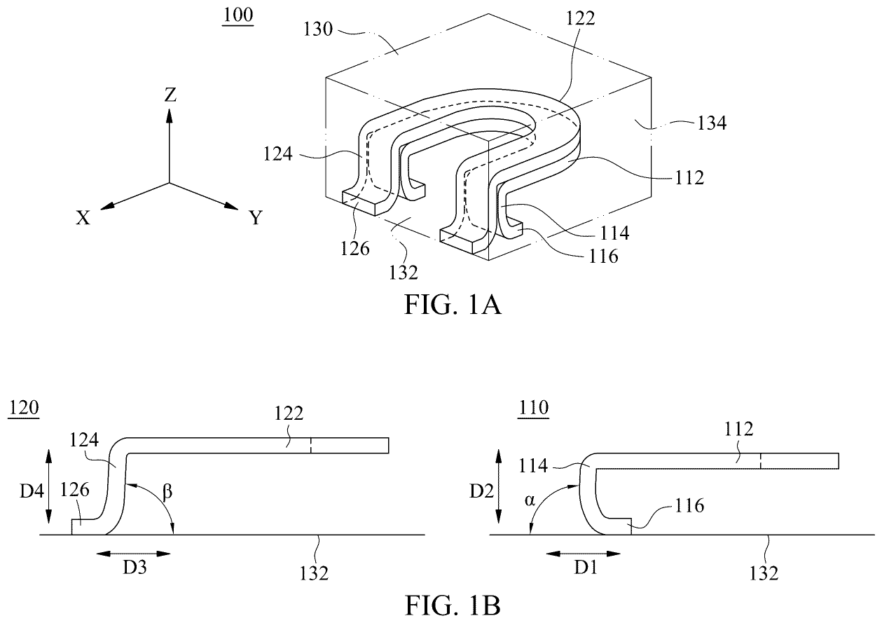

Referring to FIG. 1A and FIG. 1B simultaneously, FIG. 1A is a schematic diagram showing a 3D structure of an inductor component 100 in accordance with embodiments of the present invention, and FIG. 1B is a schematic diagram showing side views of a first winding and a second winding of the inductor component 100. The inductor component 100 is adapted to a Trans-inductor Voltage Regulator (TLVR), and includes a first winding 110, a second winding 120, a housing 130, and a magnetic core (not shown). The first winding 110 and the second winding 120 are used to be a primary winding and a secondary winding of the TLVR, respectively.

The first winding 110 includes: a first main portion 112, two first bending portions 114 and two first bonding portions 116. The first bonding portions 116 extend along a first direction D1 and are disposed on a bottom surface 132 of the housing 130. The first bending portions 114 are connected to the first bonding portions 116 and extend along a second direction D2, in which the second direction D2 is different from the first direction D1. The first main portion 112 is connected between the first bending portions 114 and defines a first winding surrounded area of the first winding 110.

The second winding 120 includes: a second main portion 122, two second bending portions 124 and two second bonding portions 126. The second bonding portions 126 extend along the third direction D3 and are disposed on the bottom surface 132 of the housing 130. The second bending portions 124 are connected to the second bonding portions 126 and extend along a fourth direction D4, in which the fourth direction D4 is different from the third direction D3. The second main portion 122 is connected between the second bending portions 124 and defines a winding surrounded area of the second winding 120. In this embodiment, the fourth direction D4 is the same as the second direction D2.

The magnetic flux of the inductor component 100 is related to the first main portion 112 of the first winding 110 and the second main portion 122 of the second winding 120. In this embodiment, the first main portion 112 of the first winding 110 and the second main portion 122 of the second winding 120 are conformal, but the embodiments of the present invention are not limited thereto.

In this embodiment, the first bonding portions 116 and the second bonding portions 126 extend along the bottom surface 132 of the housing 130, and the first bending portions 114 and the second bending portions 124 do not extend along the bottom surface 132. For example, an angle α is included by the first bending portions 114 and the bottom surface 132, and the angle α is greater than 0 degrees. For another example, an angle β is included by the second bending portions 124 and the bottom surface 132, and the angle β is greater than 0 degrees. In this embodiment, the angle α and the angle β are substantially equal to 90 degrees. In other words, the first bending portions 114 and the second bending portions 124 extend perpendicularly to the bottom surface 132.

Specifically, in this embodiment, the first bonding portions 116, the second bonding portions 126, the first main portion 112 and the second main portion 122 extend along the first direction D1 and the third direction D3, and the first direction D1 and the third direction D3 correspond to the X-axis direction of the XYZ coordinate axis. The first bending portions 114 and the second bending portions 124 extend along the second direction D2 and the fourth direction D4. The second direction D2 and the fourth direction D4 correspond to the Z-axis direction of the XYZ coordinate axis.

In order to decrease the height of the inductor component 100, in this embodiment, the first main portion 112 of the first winding 110 and the second main portion 122 of the second winding 120 are designed to extend along the bottom surface 132 rather than along the direction of the first bonding portions 116 and the second bonding portions 126 (for example, the Z-axis direction), so that the inductor component 100 have a smaller height accordingly.

Regarding the housing 130, the bottom surface 132 of the housing 130 has a larger area, and each of the side surfaces 134 adjacent to the bottom surface 132 has a smaller area. The first winding 110 and the second winding 120 of the inductor component 100 of this embodiment are disposed parallel to the bottom surface 132 (the first main portion 112 and the second main portion 122), and when the first winding 110 and the second winding 120 are led out for forming pins, extending directions of the first winding 110 and the second winding 120 are changed (the first bending portions 114 and the second bending portions 124), so that the first bonding portions 116 and the second bonding portions 126 of the first winding 110 and the second winding 120 can be disposed on the bottom surface 132 and connected to an external component (such as a circuit board). Therefore, the first winding 110 and the second winding 120 of this embodiment have a larger winding surrounded area (corresponding to a larger bottom surface 132), and an overall height is also smaller.

In one embodiment of the present invention, the first winding 110 and the second winding 120 can be made of metal conductive materials (for example, copper). The first winding 110 and the second winding 120 can be obtained by processing the metal conductive material by wire-EDM or punching. Insulation material (not shown) is disposed between the first winding 110 and the second winding 120 to prevent the first winding 110 and the second winding 120 from being short-circuited. In another embodiment of the present invention, the first winding 110 and the second winding 120 may be made of enameled wires respectively.

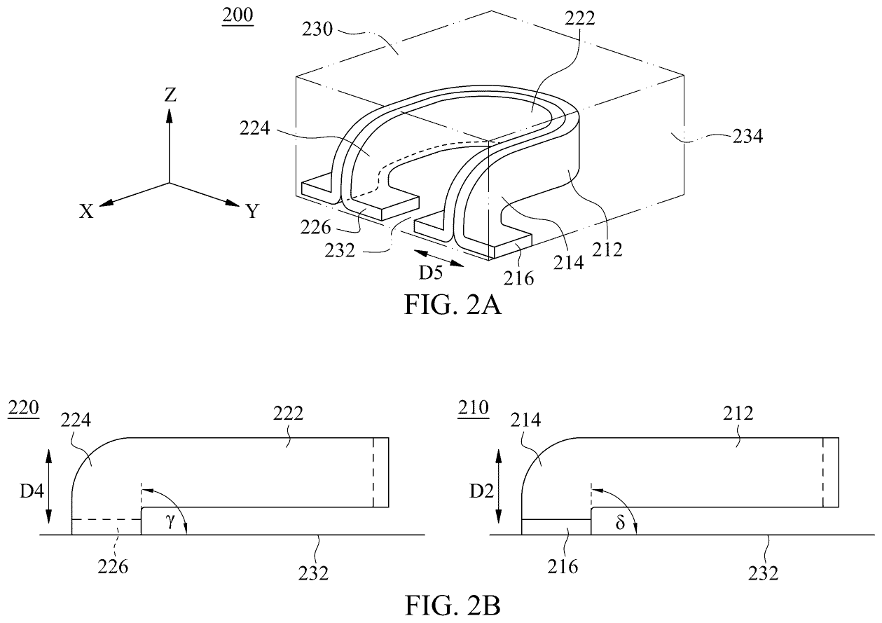

Referring to FIG. 2A and FIG. 2B simultaneously, FIG. 2A is a schematic diagram showing a 3D structure of an inductor component 200 in accordance with embodiments of the present invention, and FIG. 2B is a schematic diagram showing side views of a first winding and a second winding of the inductor component 200. The inductor component 200 is similar to the above inductor component 100, and includes a first winding 210, a second winding 220, a housing 230, and a magnetic core (not shown). The first winding 210 and the second winding 220 are used to be a primary winding and a secondary winding of the TLVR, respectively.

The first winding 210 includes: a first main portion 212, two first bending portions 214 and two first bonding portions 216. The first bonding portions 216 extend along a fifth direction D5 and are disposed on a bottom surface 232 of the housing 230. The first bending portions 214 are connected to the first bonding portions 216 and extend along the second direction D2, in which the fifth direction D5 is different from the second direction D2. The first main portion 212 is connected between the first bending portions 214 and defines a first winding surrounded area of the first winding 210.

The second winding 220 includes: a second main portion 222, two second bending portions 224 and two second bonding portions 226. The second bonding portions 126 extend along the fifth direction D5 and are disposed on the bottom surface 232 of the housing 230. The second bending portions 224 are connected to the second bonding portions 226 and extend along the fourth direction D4, in which the fifth direction D5 is different from the fourth direction D4. The second main portion 222 is connected between the second bending portions 224 and defines a winding surrounded area of the second winding 220.

The magnetic flux of the inductor component 200 is related to the first main portion 212 of the first winding 210 and the second main portion 222 of the second winding 220. In this embodiment, the first main portion 212 of the first winding 210 and the second main portion 222 of the second winding 220 are conformal, but the embodiments of the present invention are not limited thereto.

In this embodiment, the first bonding portions 216 and the second bonding portions 226 extend along the bottom surface 232 of the housing 230, and the first bending portions 214 and the second bending portions 224 do not extend along the bottom surface 232. For example, an angle δ is included by the first bending portions 214 and the bottom surface 232, and the angle δ is greater than 0 degrees. For another example, an angle γ is included by the second bending portions 224 and the bottom surface 232, and the angle γ is greater than 0 degrees. In this embodiment, the angle δ and the angle γ are substantially equal to 90 degrees. In other words, the first bending portions 214 and the second bending portions 224 extend perpendicularly to the bottom surface 232.

Specifically, in this embodiment, the first bonding portions 216 and the second bonding portions 226 extend along the fifth direction D5. The fifth direction D5 corresponds to the Y-axis direction of the XYZ coordinate axis. The first main portion 212 and the second main portion 222 extend along the first direction D1 and the third direction D3. The first direction D1 and the third direction D3 correspond to the X-axis direction of the XYZ coordinate axis. The first bending portions 214 and the second bending portions 224 extend along the second direction D2 and the fourth direction D4. The second direction D2 and the fourth direction D4 correspond to the Z-axis direction of the XYZ coordinate axis.

Similar to the inductor component 100, in the inductor component 200 of this embodiment, the first main portion 212 of the first winding 210 and the second main portion 222 of the second winding 220 are designed to extend along the bottom surface 232 rather than extending along the direction of the first bonding portions 216 and the second bonding portions 226, so that the inductor component 200 has a smaller height.

Regarding the housing 230, the bottom surface 232 of the housing 230 has a larger area, and each of the side surfaces 234 adjacent to the bottom surface 232 has a smaller area. The first winding 210 and the second winding 220 of the inductor component 200 of this embodiment are disposed parallel to the bottom surface 232 (the first main portion 212 and the second main portion 222), and when the first winding 210 and the second winding 220 are led out for forming pins, extending directions of the first winding 210 and the second winding 220 are changed (the first bending portions 214 and the second bending portions 224), so that the first bonding portions 216 and the second bonding portions 226 of the first winding 210 and the second winding 220 can be disposed on the bottom surface 232 and connected an external component (such as a circuit board). Therefore, the inductor component 200 of this embodiment has a larger winding surrounded area (corresponding to the larger bottom surface 232), and a smaller overall height (corresponding to the heights of the first bending portions 214 and the second bending portions 224).

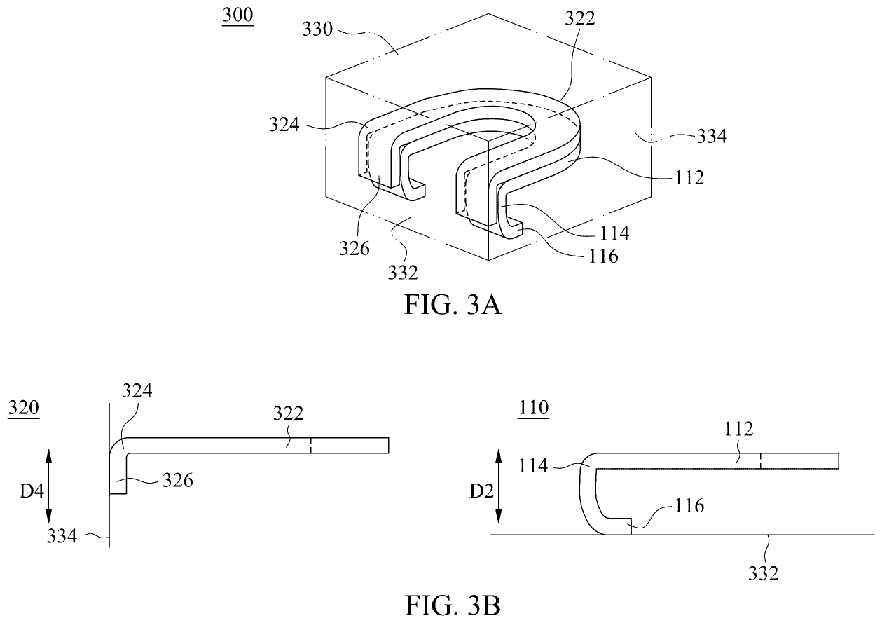

Referring to FIG. 3A and FIG. 3B simultaneously, FIG. 3A is a schematic diagram showing a 3D structure of an inductor component 300 in accordance with embodiments of the present invention, and FIG. 3B is a schematic diagram showing side views of a first winding and a second winding of the inductor component 300. The inductor component 300 is similar to the above inductor component 100, and includes the first winding 110, a second winding 320, a housing 330, and a magnetic core (not shown). The first winding 110 and the second winding 320 are used to be a primary winding and a secondary winding of the TLVR, respectively. The structure of the first winding 110 is illustrated above and not repeated herein.

The second winding 320 includes: a second main portion 322, two second bending portions 324 and two second bonding portions 326. The second bonding portions 326 extend along the fourth direction D4 and are disposed on the side surface 334 of the housing 330. The second bending portions 324 are connected to the second bonding portions 326 so that the second winding 320 is bent along the side surface 334 and the top surface of the housing 330. For example, the second bending portions 324 can be considered to extend from the top surface of the housing 330 toward the side surface 334, such that the second winding 320 is bent downward. The second main portion 322 is connected between the second bending portions 324 and defines a second winding surrounded area of the second winding 320.

The magnetic flux of the inductor component 300 is related to the first main portion 112 of the first winding 110 and the second main portion 322 of the second winding 320. In this embodiment, the first main portion 112 of the first winding 110 and the second main portion 322 of the second winding 320 are conformal, but the embodiments of the present invention are not limited thereto.

Similar to the inductor component 100, in the inductor component 300 of this embodiment, the first main portion 112 of the first winding 110 and the second main portion 322 of the second winding 320 are designed to extend along the bottom surface 332, so that the inductor component 300 has a smaller height.

Regarding the housing 330, the bottom surface 332 of the housing 330 has a larger area, and each of the side surfaces 334 adjacent to the bottom surface 332 has a smaller area. The first winding 110 and the second winding 320 of the inductor component 300 of this embodiment are disposed parallel to the bottom surface 332 (the first main portion 112 and the second main portion 322), and when the first winding 110 and the second winding 320 are led out for forming pins, extending directions of the first winding 110 and the second winding 320 (the first bending portions 114 and the second bending portions 324) are changed, so that the first bonding portions 116 and the second bonding portions 326 of the first winding 110 and the second winding 320 can be respectively disposed on the bottom surface 332 and the side surface 334, and connected to an external component (such as a circuit board). Therefore, the inductor component 300 of this embodiment has a larger winding surrounded area (corresponding to a larger bottom surface 332), and a smaller overall height (corresponding to the heights of the first bending portions 114).

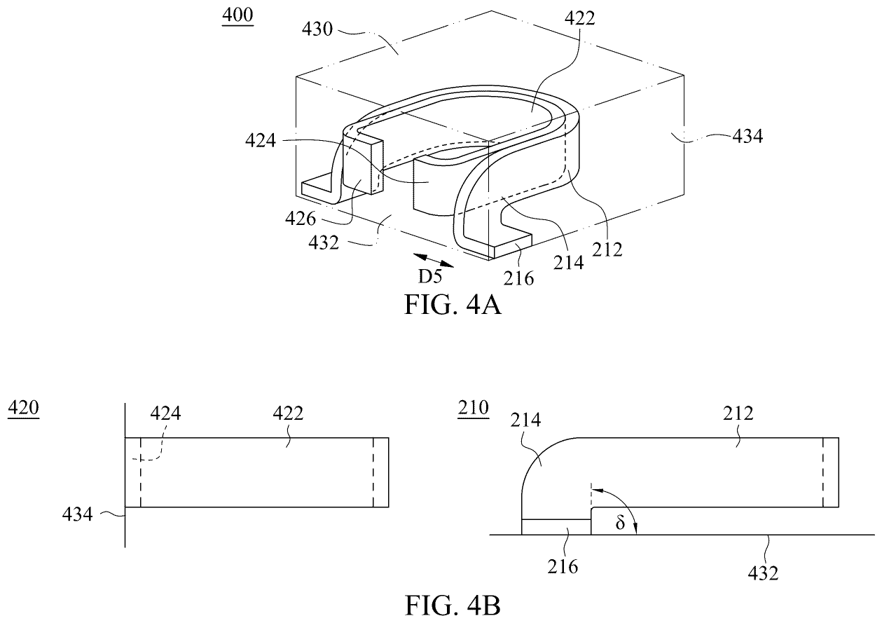

Referring to FIG. 4A and FIG. 4B simultaneously, FIG. 4A is a schematic diagram showing a 3D structure of an inductor component 400 in accordance with embodiments of the present invention, and FIG. 4B is a schematic diagram showing side views of a first winding and a second winding of the inductor component 400. The inductor component 400 is similar to the above inductor component 200, and includes the first winding 210, a second winding 420, a housing 430, and a magnetic core (not shown). The first winding 210 and the second winding 420 are used to be a primary winding and a secondary winding of the TLVR, respectively. The structure of the first winding 210 is illustrated above and not repeated herein.

The second winding 420 includes: a second main portion 422, two second bending portions 424 and two second bonding portions 426. The second bonding portions 426 extend along the fifth direction D5 and are disposed on the side surface 434 of the housing 430. The second bending portions 424 are connected to the second bonding portions 426 so that the second winding 420 is bent along two adjacent side surfaces 434 of the housing 430. For example, the second bending portions 424 can be considered to extend from one side surface 434 toward the other side surface 434 to bend the second winding wire 420. The second main portion 422 is connected between the second bending portions 424 and defines a second winding surrounded area of the second winding 420.

Therefore, the magnetic flux of the inductor component 400 is related to the first main portion 212 of the first winding 210 and the second main portion 422 of the second winding 420. In this embodiment, the first main portion 212 of the first winding 210 and the second main portion 422 of the second winding 420 are conformal, but the embodiments of the present invention are not limited thereto.

Similar to the inductor component 200, in the inductor component 400 of the this embodiment, the first main portion 212 of the first winding 210 and the second main portion 422 of the second winding 420 are designed to extend along the bottom surface 432, so that the inductor component 400 has a smaller height.

Regarding the housing 430, the bottom surface 432 of the housing 430 has a larger area, and each of the side surfaces 434 adjacent to the bottom surface 432 has a smaller area. The first winding 210 and the second winding 420 of the inductor component 400 of this embodiment are disposed parallel to the bottom surface 432 (the first main portion 212 and the second main portion 422), and when the first winding 210 and the second winding 420 are led out for forming pins, extending directions of the first winding 210 and the second winding 420 are changed (the first bending portions 214 and the second bending portions 424), so that the first bonding portion 216 and the second bonding portion 426 of the first winding 210 and the second winding 420 can be respectively disposed on the bottom surface 432 and the side surface 434, and connected to an external component (such as a circuit board). Therefore, the inductor component 400 of this embodiment has a larger winding surrounded (corresponding to a larger bottom surface 432), and a smaller overall height (corresponding to the heights of the first bending portions 214 and the second bending portions 424).

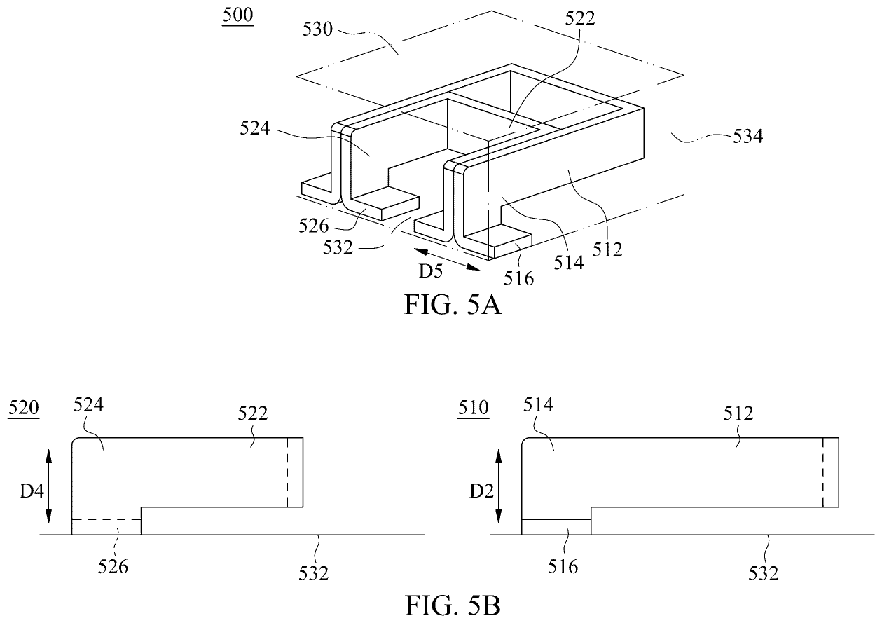

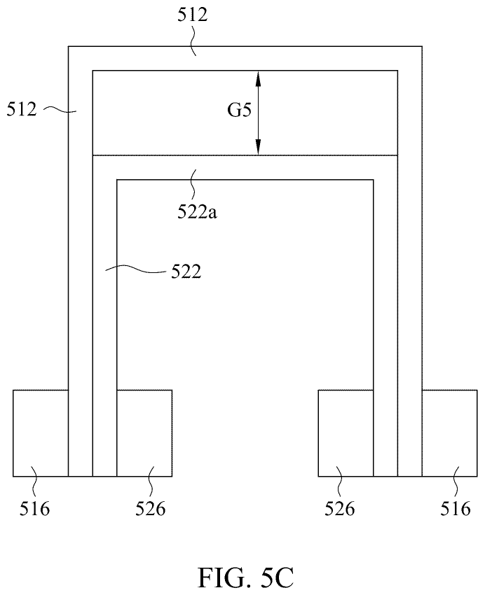

Referring to FIG. 5A-5C, FIG. 5A is a schematic diagram showing a 3D structure of an inductor component 500 in accordance with embodiments of the present invention, FIG. 5B is a schematic diagram showing side views of a first winding and a second winding of the inductor component 500, and FIG. 5C is a schematic diagram showing a top view of the first winding and the second winding of the inductor component 500. The inductor component 500 is similar to the above inductor component 200 and includes a first winding 510, a second winding 520, a housing 530 and a magnetic core (not shown). The first winding 510 and the second winding 520 are used to be a primary winding and a secondary winding of the TLVR, respectively. The first winding 510 includes a first main portion 512, two first bending portions 514 and two first bonding portions 516. The first bonding portions 516 extend along the fifth direction D5 and are disposed on the bottom surface 532 of the housing 530. The first bending portions 514 are connected to the first bonding portions 516 and extend along the second direction D2. The first main portion 512 is connected between the first bending portions 514 and defines a first winding surrounded area of the first winding 510.

The second winding 520 includes: a second main portion 522, two second bending portions 524 and two second bonding portions 526. The second bonding portions 526 extend along the fifth direction D5 and are disposed on the bottom surface 532 of the housing 530. The second bending portions 524 are connected to the second bonding portions 526 and extend along the fourth direction D4. The second main portion 522 is connected between the second bending portions 524 and defines a second winding surrounded area of the second winding 520.

Similar to the inductor component 200, in the inductor component 500 of this embodiment, the first main portion 512 of the first winding 510 and the second main portion 522 of the second winding 520 are designed to extend along the bottom surface 532, so that the inductor component 500 has a smaller height.

Regarding the housing 530, the bottom surface 532 of the housing 530 has a larger area, and each of the side surfaces 534 adjacent to the bottom surface 532 has a smaller area. The first winding 510 and the second winding 520 of the inductor component 500 of this embodiment are disposed parallel to the bottom surface 532 (the first main portion 512 and the second main portion 522), and when the first winding 510 and the second winding 520 are led out of for forming pins, extending directions of the first winding 510 and the second winding 520 are changed (the first bending portions 514 and the second bending portions 524), so that the first bonding portions 516 and the second bonding portions 526 of the first winding 510 and the second winding 520 can be disposed on the bottom surface 532 and connected to an external component (such as a circuit board). Therefore, the inductor component 500 of this embodiment has a larger winding surrounded area (corresponding to the larger bottom surface 532) and a smaller overall height (corresponding to the height of the first bending portions 514 and the second bending portions 524).

In addition, in this embodiment, the second winding 520 is located in the first winding surrounded area of the first winding 510, and a gap G5 is defined between the first main portion 512 of the first winding 510 and the second main portion 522 of the second winding 520. In this embodiment, the second main portion 522 has an adjustment portion 522a, and the adjustment portion 522a can be designed in accordance with desired inductance characteristics to change a width of the gap, thereby enabling the inductance characteristics of the inductor component 500 to meet demands of a user.

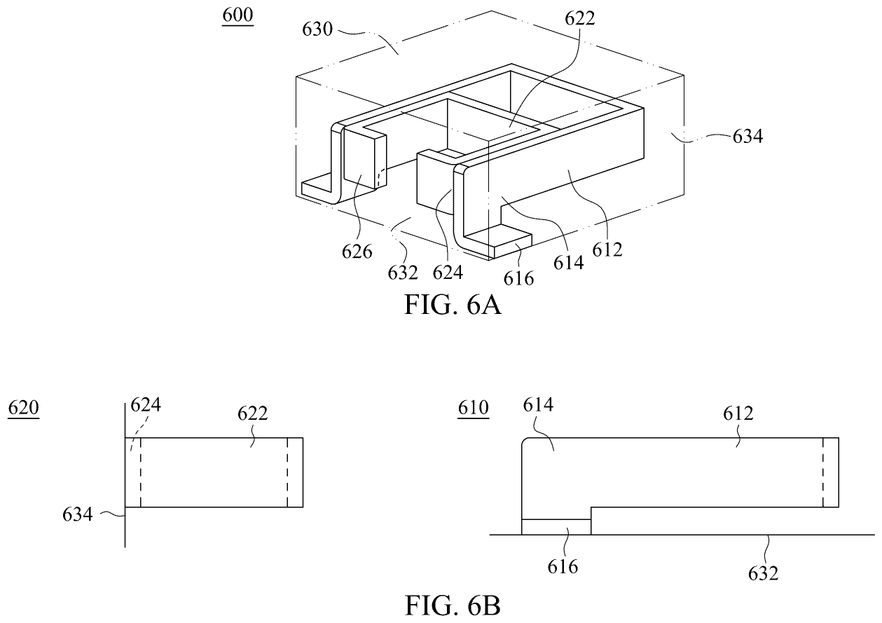

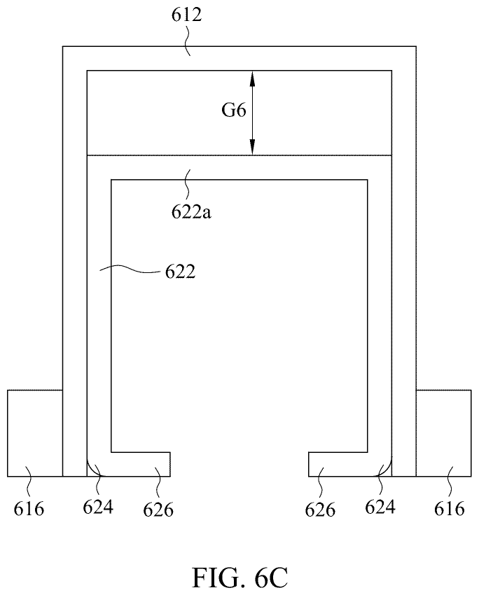

Referring to FIG. 6A-6C, FIG. 6A is a schematic diagram showing a 3D structure of an inductor component 600 in accordance with embodiments of the present invention, FIG. 6B is a schematic diagram showing side views of a first winding and a second winding of the inductor component 600, and FIG. 6C is a schematic diagram showing a top view of the first winding and the second winding of the inductor component 600. The inductor component 600 is similar to the above inductor component 400 and includes a first winding 610, a second winding 620, a housing 630 and a magnetic core (not shown). The first winding 610 and the second winding 620 are used to be a primary winding and a secondary winding of the TLVR, respectively. The first winding 610 includes a first main portion 612, two first bending portions 614 and two first bonding portions 616. The first bonding portions 616 extend along the fifth direction D5 and are disposed on the bottom surface 632 of the housing 630. The first bending portions 614 are connected to the first bonding portions 616 and extend along the second direction D2. The first main portion 612 is connected between the first bending portions 614 and defines a first winding surrounded of the first winding 610.

The second winding 620 includes: a second main portion 622, two second bending portions 624 and two second bonding portions 626. The second bonding portions 626 extend along the fifth direction D5 and are disposed on the side surface 634 of the housing 630. The second bending portions are connected to the second bonding portions 626 and extend along the fourth direction D4. The second main portion 622 is connected between the second bending portions 624 and defines a second winding surrounded area of the second winding 620.

Similar to the inductor component 400, in the inductor component 600 of the this embodiment, the first main portion 612 of the first winding 610 and the second main portion 622 of the second winding 620 are designed to extend along the bottom surface 632, so that the inductor component 600 has a smaller height.

Regarding the housing 630, the bottom surface 632 of the housing 630 has a larger area, and each of the side surfaces 634 adjacent to the bottom surface 632 has a smaller area. The first winding 610 and the second winding 620 of the inductor component 600 of this embodiment are disposed parallel to the bottom surface 632 (the first main portion 612 and the second main portion 622), and when the first winding 610 and the second winding 620 are led out for forming pins, extending directions of the first winding 610 and the second winding 620 are changed (the first bending portions 614 and the second bending portions 624), so that the first bonding portions 616 and the second bonding portions 626 of the first winding 610 and the second winding 620 can be respectively disposed on the bottom surface 632 and the side surface 634, and connected to an external component (such as a circuit board). Therefore, the inductor component 600 of this embodiment has a larger winding surrounded area (corresponding to the larger bottom surface 632), and a smaller overall height (corresponding to the height of the first bending portions 614 and the second bending portions 624).

In addition, in this embodiment, the second winding 620 is located in the first winding surrounded area of the first winding 610, and a gap G6 is defined between the first main portion 612 of the first winding 610 and the second main portion 622 of the second winding 620. In this embodiment, the second main portion 622 has an adjustment portion 622a, and the adjustment portion 622a can be designed in accordance with desired inductance characteristics to change a width of the gap, thereby enabling the inductance characteristics of the inductor component 600 to meet demands of a user.

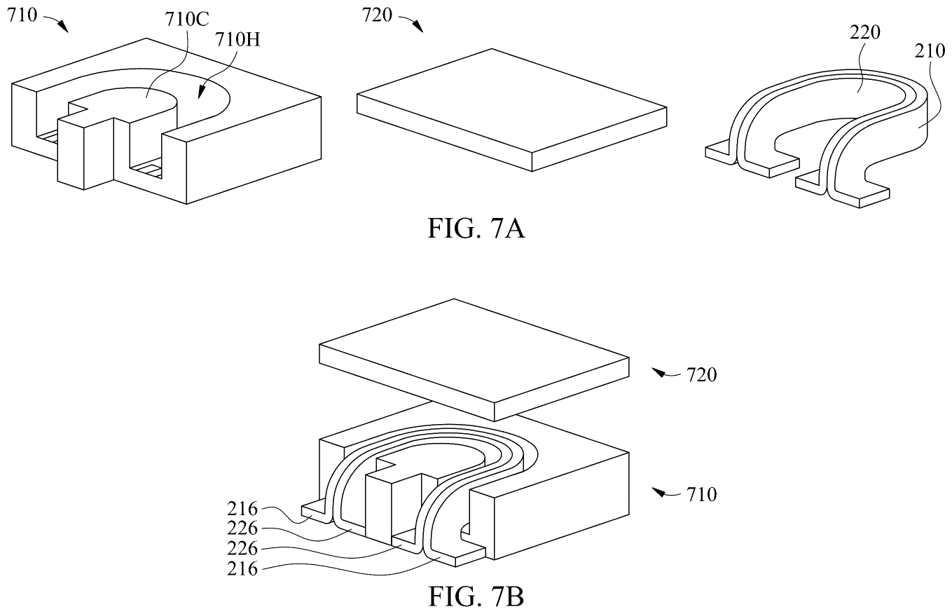

Referring to FIG. 7A and FIG. 7B simultaneously, FIG. 7A is a schematic diagram showing a bottom portion 710 and a top portion 720 of a magnetic body, the first winding 210 and the second winding 220 (also referred as to winding group hereinafter), FIG. 7B is a schematic diagram showing combination of the winding group and the magnetic body. As shown in FIG. 7A, in this embodiment, the bottom portion 710 of the magnetic body has a groove portion 710H and a center portion 710C. The groove portion 710H is used to receive the winding group, so that the center portion 710C is located in the winding surrounded area of the winding group. As shown in FIG. 7B, when the winding group is disposed in the groove portion 710H and the top portion 720 covers the bottom portion 710, the first bonding portions 216 and the second bonding portions 226 of the winding group are exposed for convenience of subsequent component bonding processes.

In this embodiment, the magnetic body includes ferromagnetic material particles and insulating material particles. The magnetic body of this embodiment can be obtained by processing the ferromagnetic material particles and the insulating material particles by using die-casting technology. The magnetic body can be regarded as the magnetic core of the inductor component and the magnetic body is non-conductive.

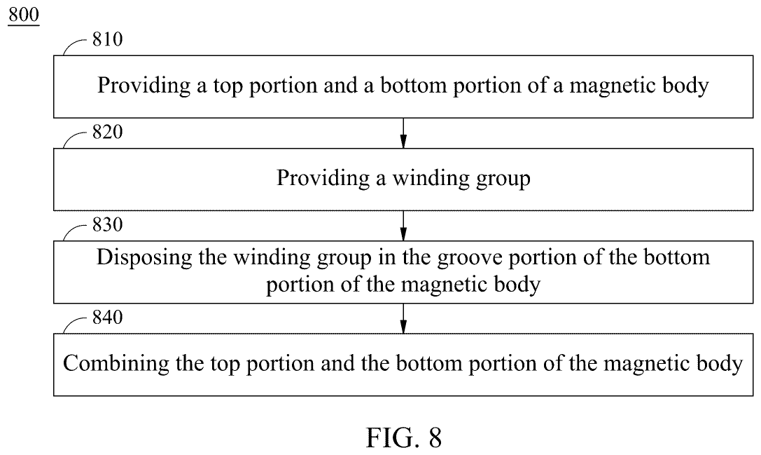

Referring to FIG. 8, FIG. 8 is a schematic diagram showing a flow chart of a method 800 for manufacturing the above inductor component in accordance with embodiments of the present invention. In step 810, the top portion 720 and the bottom portion 710 of the magnetic body are provided. In step 820, the winding group, for example including the first winding 210 and the second winding 220, is provided. In step 830, the winding group is disposed in the groove portion 710H of the bottom portion 710 of the magnetic body. In step 840, the top portion 720 and the bottom portion 710 of the magnetic body are combined to enclose the winding group in the magnetic body.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An inductor component, comprising:
a first winding comprising:
two first bonding portions extending along a first direction;
two first bending portions connected to the first bonding portions and extending along a second direction different from the first direction; and
a first main portion connected between the first bending portions and defining a first winding surrounded area of the first winding; and
a second winding comprising:
two second bonding portions extending along a third direction;
two second bending portions connected to the second bonding portions and extending along a fourth direction different from the third direction; and
a second main portion connected between the second bending portions and defining a second winding surrounded area of the second winding;
wherein the first main portion is conformal to the second main portion.

2. The inductor component of claim 1, wherein the first bonding portions and the second bonding portions extend along a plane, and the first main portion and the second main portion extend along the plane.

3. The inductor component of claim 2, wherein the first bending portions and the second bending portions do not extend along the plane, and an angle between the first bending portions and the plane is greater than 0 degrees, and an angle between the second bending portions and the plane is greater than 0 degrees.

4. The inductor component of claim 3, wherein the angle between the first bending portions and the plane is 90 degrees, and an angle between the second bending portions and the plane is 90 degrees.

5. The inductor component of claim 1, further comprising a housing, wherein
the first winding and the second winding are disposed in the housing;
the first bonding portions and the second bonding portions are disposed on a bottom surface of the housing.

6. The inductor component of claim 1, further comprising a housing, wherein
the first winding and the second winding are disposed in the housing;
the first bonding portions are disposed on a bottom surface of the housing;
the second bonding portions are disposed on a side surface of the housing, and the side surface is adjacent to the bottom surface.

7. The inductor component of claim 1, further comprising a housing, wherein the second main portion is located in the first winding surrounded area.

8. An inductor component, comprising:
a first winding comprising:
two first bonding portions extending along a first direction;
two first bending portions connected to the first bonding portions and extending along a second direction different from the first direction; and
a first main portion connected between the first bending portions and defining a first winding surrounded area of the first winding; and
a second winding comprising:
two second bonding portions extending along a third direction;
two second bending portions connected to the second bonding portions and extending along a fourth direction different from the third direction; and
a second main portion connected between the second bending portions and defining a second winding surrounded area of the second winding;
wherein the second main portion is located in the first winding surrounded area, and there is a gap located between the first main portion and an adjustment portion of the second main portion.

9. The inductor component of claim 8, wherein the first bonding portions and the second bonding portions extend along a plane, and the first main portion and the second main portion extend along the plane.

10. The inductor component of claim 9, wherein the first bending portions and the second bending portions do not extend along the plane, and an angle between the first bending portions and the plane is greater than 0 degrees, and an angle between the second bending portions and the plane is greater than 0 degrees.

11. The inductor component of claim 10, wherein the angle between the first bending portions and the plane is 90 degrees, and an angle between the second bending portions and the plane is 90 degrees.

12. The inductor component of claim 8, further comprising a housing, wherein
the first winding and the second winding are disposed in the housing;
the first bonding portions and the second bonding portions are disposed on a bottom surface of the housing.

13. The inductor component of claim 8, further comprising a housing, wherein
the first winding and the second winding are disposed in the housing;
the first bonding portions are disposed on a bottom surface of the housing;
the second bonding portions are disposed on a side surface of the housing, and the side surface is adjacent to the bottom surface.

14. An inductor component, comprising:
a first winding comprising:
two first bonding portions extending along a first direction;
two first bending portions connected to the first bonding portions and extending along a second direction different from the first direction; and
a first main portion connected between the first bending portions and defining a first winding surrounded area of the first winding; and
a second winding comprising:
two second bonding portions extending along a third direction;
two second bending portions connected to the second bonding portions and extending along a fourth direction different from the third direction; and
a second main portion connected between the second bending portions and defining a second winding surrounded area of the second winding;
a magnetic body for receiving the first winding and the second winding, comprising:
a top portion; and
a bottom portion located under the top portion, comprising:
a groove portion for receiving the first winding and the second winding; and
a center portion located in the first winding surrounded area and the second winding surrounded area.

15. The inductor component of claim 14, wherein the magnetic body comprises ferromagnetic material particles and insulating material particles.
